(19) United States
(12) Patent Application Publication
(10) Pub. No.: US 2024/0093711 A1
(43) Pub. Date: Mar. 21, 2024

(54) BLIND RIVET, AND SYSTEM AND METHOD FOR MAKING SEALED BLIND RIVET JOINTS

(71) Applicant: Airbus Operations GmbH, HAMBURG (DE)

(72) Inventor: Jörn SKIRKE, HAMBURG (DE)

(21) Appl. No.: 18/460,896

(22) Filed: Sep. 5, 2023

(30) Foreign Application Priority Data
Sep. 16, 2022 (EP) 22196041.2

(51) Int. Cl. F16B 19/10; F16B 19/00

(52) U.S. Cl. CPC F16B 19/1036; F16B 19/008

(57) ABSTRACT

A blind rivet, for connecting workpieces, comprising a hollow, deformable rivet body with a bearing collar and a sleeve attached thereto, a rivet mandrel in the sleeve and extending through the bearing collar, having a tool holder head, and a sealing ring. The sealing ring is arranged between the bearing collar and the tool holder head and is made of a curable and not fully cured sealing material. During contraction of the blind rivet, the sealing ring is pressed axially towards the bearing collar by a tool that can be connected to the tool holder head or by a section of the rivet mandrel. The sealing ring is designed to flow radially and axially into gaps and spaces on the bearing collar and between the bearing collar and the workpieces while the sealing ring is compressed, and to adhere there.

### CROSS-REFERENCES TO RELATED APPLICATIONS

This application claims the benefit of European Patent Application Number 22196041-2 filed on Sep. 16, 2022, the entire disclosure of which is incorporated herein by way of reference.

### FIELD OF THE INVENTION

The present description relates to a blind rivet and to a system and a method for producing sealed blind rivet connections.

### BACKGROUND OF THE INVENTION

In aircraft construction, numerous rivet connections are commonly used to assemble individual aircraft components. Traditional rivet connections are executed in two parts in this case and comprise a rivet and a rivet nut. Producing the rivet connections requires a rivet hole and access to the rivet hole from both sides, so that the rivet can be inserted into the rivet hole from one side and the rivet nut can be threaded onto the rivet on the other side. This process is time-consuming and, depending on the embodiment of the workpieces, can be difficult or awkward. In addition, with larger workpieces which are not only riveted to one another at the edges, two people are needed to apply the rivet and the rivet nut.

A simplified variant for the production of rivet connections involves the use of blind rivets which only require one-sided access to a rivet hole and can also be automated using appropriate tools. In addition to significantly reducing installation time, costs and noise generation, new and different designs are made possible on account of the reduced accessibility requirements. Ergonomics are improved and the production of a rivet connection only requires a single person.

Particularly when connecting aircraft components that come into direct contact with the environment, there may be spaces, recesses or gaps that have to be sealed in the case of blind rivet connections, so that a paint layer can be applied to them smoothly and seamlessly. Suitable post-treatment typically involves applying a sealing material to the rivet connections, filling and then removing excess sealing material. However, this process can in some cases be time-consuming and may to some extent offset the time savings and cost reductions made with the blind rivet assembly.

### SUMMARY OF THE INVENTION

An object of the invention is therefore to propose a blind rivet, a connection system and/or a method for producing a blind rivet connection, in which the amount of manual work involved in the post-treatment can be reduced.

This object is achieved by a blind rivet having the features of at least one embodiment described herein. Advantageous embodiments and developments of the invention can be found in additional embodiments and the following description.

A blind rivet for connecting workpieces is proposed, comprising a hollow, deformable rivet body with a bearing collar and a sleeve attached thereto, a rivet mandrel arranged in the sleeve and extending through the bearing collar, having a tool holder head, and at least one sealing ring, wherein the at least one sealing ring is arranged between the bearing collar and the tool holder head, wherein the at least one sealing ring is made of a curable and not fully cured sealing material, wherein the at least one sealing ring is arranged in such a manner that during contraction of the blind rivet it is pressed axially towards the bearing collar by a tool that can be connected to the tool holder head or by a section of the rivet mandrel, and wherein the at least one sealing ring is designed to flow radially and axially into gaps and spaces on the bearing collar and between the bearing collar and the workpieces while the sealing ring is compressed, and to adhere there.

An alternative blind rivet is proposed according to the invention, which, through tool-guided contraction, automatically leads to complete sealing of the blind rivet connection on the workpieces. Conventional tools can be used for fastening the blind rivet, which are also used in typical riveting processes. The advantages of the blind rivet connection explained earlier over a conventional rivet connection as explained above can be maintained, while substantially reducing the amount of work involved in post-treatments, in particular grinding work, since gaps and spaces are filled automatically. The essential components of the blind rivet required for this purpose are described below.

The rivet body includes primarily of the sleeve, which is inserted into a rivet hole in the workpieces to be connected. The insertion depth is limited by the bearing collar, which rests on an edge surface surrounding the rivet hole. The sleeve is designed in such a way that it is deformed by a tensile force, which pulls an end of the sleeve facing away from the rivet hole towards the rivet hole. In this way, the sleeve is shortened in the axial direction and expands in the radial direction, causing it to be squeezed against the workpieces on a side facing away from the bearing collar. The workpieces are then clamped between the bearing collar and the deformed part of the sleeve.

The rivet mandrel is intended to pull the rivet body, as described, to the rivet hole. This can be done in various ways. In a first variant, the rivet mandrel could only have a tensile-strength connection with the end of the rivet body facing away from the bearing collar and be pulled by the tool attached to the rivet mandrel. In a second variant, the sleeve could have an internal thread and the rivet mandrel a complementary external thread. Driven by the tool, the rivet mandrel can be rotated, so that a tensile force is applied to the respective end of the rivet body by the interlocking threads, which results in the desired deformation of the sleeve.

The tool holder head is intended to establish a connection between the rivet mandrel and the tool. The tool holder head can establish a non-rotatable or tensile-strength bond, depending on the design of the rivet mandrel.

The components described above are common in typical blind rivets. However, a crucial element of the blind rivet according to the invention is the at least one sealing ring which is positioned between the bearing collar and the tool holder head. The sealing ring can be removed from a container and placed onto the blind rivet before said blind rivet is assembled. Alternatively, the sealing ring is arranged on the blind rivet prior to assembly. It should be noted in this respect that the position specified is to be understood in such a way that the sealing ring could be arranged in a general form at a random or desired point between the tool holder head and the bearing collar, depending on the design of the rivet mandrel and the preference of the user. Different positioning variants will be explained further below.

The material of the sealing ring is designed such that the sealing ring is highly viscous or pasty, so that a ring shape is maintained when the blind rivet is in an unloaded state and a user could also easily apply the sealing ring onto the blind rivet or the at least one sealing ring maintains its ring shape in a supported form of the blind rivet. However, the sealing material is sufficiently plastically deformable, so that when the sealing ring is pressed, its shape is permanently altered. It is particularly sensible for the viscosity to be chosen such that the at least one sealing ring can still be smoothly coated after the blind rivet has contracted. Therefore, it should not be overly viscous either.

During creation of the rivet connection, in particular after the blind rivet has been inserted into a rivet hole, the sealing ring could be in a partially cured state, for example, and cure subsequently after the blind rivet has contracted and the seal been produced. Consequently, even with automated, tool-guided production of blind rivet connections, sealing can take place automatically. Both the application site and the amount of material applied are directly tailored to the requirements of the rivet connection created in this case. The sealing material is preferably curable, in order to provide a homogeneous, durable base for priming or painting. The sealing material is based on polysulphides, for example. An appropriate curing agent could include manganese dioxide or similar a substance.

In an advantageous embodiment, the rivet mandrel comprises an external thread at an end facing away from the tool holder head, which external thread corresponds to an internal thread in the sleeve, wherein the tool holder head has a first profile to transfer rotation from the tool to the rivet mandrel, which first profile corresponds to a second profile on the tool. This causes the rivet body to contract through the rotation of the rivet thread on account of the interlocking threads. Once a torque limit value has been reached, said value being tailored to the mechanical properties of the rivet body, and following complete contraction, the tool holder head breaks off. The tool holder head and the tool may comprise an elliptical drive system. Furthermore, the rivet body may have an opening on its side facing away from the tool holder head, through which the rivet mandrel can protrude during the contraction of the rivet body.

In an advantageous embodiment, the rivet mandrel has a circumferential collar that rests on the bearing collar of the rivet body. The circumferential collar, which can be arranged in the previously mentioned section of the rivet mandrel, or represent this, presses into an opening in the bearing collar during contraction. The opening in the bearing collar and the circumferential collar of the rivet mandrel could each have a chamfer matched to one another. This could give the circumferential collar a certain truncated cone shape that is pressed into an equally truncated cone-shaped opening. The rivet mandrel and the rivet body are thereby centered relative to one another.

In an advantageous embodiment, the at least one sealing ring is arranged between the circumferential collar and the bearing collar. Starting from the rivet mandrel and the opening in the rivet body, the sealing material consequently expands radially outwards, preferably covering the bearing collar of the rivet body completely for the most part.

In an advantageous embodiment, the at least one sealing ring is arranged between the tool holder head and the circumferential collar. In this case, a tool nose piece acts on the at least one sealing ring during the contraction of the rivet body, causing it to be squeezed radially outwards from the circumferential collar beyond the bearing collar of the rivet body. With this variant, it is important to ensure that the tool nose piece is free from contaminants and regularly coated with a release agent, where necessary. The release agent is preferably matched with the sealing material and designed to prevent adhesion of the sealing material.

In an advantageous embodiment, the bearing collar has protrusions on a side facing away from the tool holder head, said protrusions become wedged with the workpieces during the contraction of the blind rivet, preventing the rivet body from rotating. The protrusions are pressed onto a surface of the workpieces facing the bearing collar by the tool and/or the circumferential collar that presses against the bearing collar. In this way, the position of the rivet body on the workpieces is fixed, particularly in a non-rotatable manner. The at least one sealing ring allows the sealing material to be automatically introduced into any gaps or spaces.

In an advantageous embodiment, the receiving collar has notches on a side facing the tool holder head, wherein the sealing ring is dimensioned such that the notches are filled with sealing material after the contraction of the blind rivet. The sealing material is also forced radially over the notches, so they are automatically coated with the sealing material after the rivet body has contracted. It might be desirable to create a flat surface subsequently by filling. This can be done either for each rivet connection immediately following contraction or for an entire row of rivets or a similar arrangement. The notches could be designed to engage with a non-rotating nose surface of the tool, in order to counteract rotation. Since the notches are partially in contact with the nose surface, it may be necessary to smooth the sealing material with a putty knife after removing the tool, so that the notches are completely filled.

In an advantageous embodiment, the tool holder head is free from cetyl alcohol. Cetyl alcohol is often used as a lubricant for connecting elements and is typically applied to the entire connecting element. To ensure proper sealing of the rivet connection which is produced, it is wise to avoid cetyl alcohol on the tool holder head, circumferential collar, and/or the bearing collar. This means that the blind rivet can only be wetted on a section facing away from the bearing collar or the application of a lubricant of this kind is removed in the area of the bearing collar.

In an advantageous embodiment, the blind rivet has a resin coating. Exemplary coatings could include aluminum-pigmented coatings according to EN 4473. A resin coating is particularly advantageous for adhesion of the sealing material or a primer or coat of paint.

In an advantageous embodiment, the at least one sealing ring is heat-curable, UV-curable and/or moisture-curing. Curing of the sealing material can be controlled through appropriate application of heat or UV light. Alternatively, it is conceivable for curing to be initiated by ambient humidity. In the latter case, no further precautions need be taken after the at least one sealing ring has been attached. The blind rivet could also be stored in a cooled state, interrupting curing of the sealing ring made of a heat-curable sealing material, wherein curing takes place after the blind rivet connection has been made due to the ambient temperature.

In an advantageous embodiment, the at least one sealing ring can be filled immediately following the contraction of the blind rivet. The sealing material must not therefore be excessively viscous in its applied state, allowing it to be manually spread or smoothed with a putty knife. However, it should be sufficiently paste-like or viscous to retain its shape after filling and not to flow off or drip off if the connection is not arranged completely horizontally.

In an advantageous embodiment, the at least one sealing ring is a two-component mixture, which is prepared before attaching the at least one sealing ring or is realized in the form of two contactable sealing rings with components which are separate from one another and mix with one another upon contraction. The two sealing rings therefore form the curable sealing material only after the two sealing rings have been pressed together accordingly.

The invention also relates to a system for producing sealed blind rivet connections, comprising at least one blind rivet according to the preceding description and at least one tool that can be connected to the tool holder head. The tool is adapted to the design of the blind rivet and could be provided both to exert a pure tensile force and to exert rotation. The tool could be electrically or pneumatically configured.

In an advantageous embodiment, the tool has a tool nose piece with a nose surface that can be brought into contact with the at least one sealing ring, wherein the nose surface is coated with a release agent. The tool nose piece may have a rivet mandrel receptacle which is surrounded by a ring-shaped surface, for example. This surface may press against the rivet body when the blind rivet contracts. If the at least one sealing ring is positioned between the bearing collar and the tool holder head, the nose surface can press against the at least one sealing ring and thereby compress the sealing material axially and radially, as described earlier. The release agent helps prevent adhesion. It is preferred for the cleanliness of the tool nose piece to be regularly checked, regularly wiping it with a lint-free cloth, for example, and applying a release agent where appropriate.

Furthermore, the invention relates to a method for producing sealed blind rivet connections on workpieces, involving the steps of creating a rivet hole in the workpieces, inserting a blind rivet according to the invention into the rivet hole and contracting the rivet body using a tool while pressing the at least one sealing ring. The sealing material could then be filled subsequently, if desired.

In an advantageous embodiment, the at least one sealing ring is a two-component mixture which is formed into a ring-shaped bead before the blind rivet is inserted and placed onto the blind rivet.

In an advantageous embodiment, the at least one sealing ring is removed immediately before the blind rivet is inserted from an airtight and/or cooled packaging and placed onto the blind rivet or the blind rivet with the sealing ring fitted is removed immediately prior to insertion from an airtight and/or cooled packaging.

Furthermore, the method may involve filling the sealing material after the at least one sealing ring has been compressed.

### BRIEF DESCRIPTION OF THE DRAWINGS

The exemplary embodiments are explained in greater detail below with reference to the attached drawings. The depictions are schematic and not to scale. Identical reference signs refer to identical or similar elements. In the drawings:

FIG. 1 shows a schematic representation of a blind rivet according to an exemplary embodiment in an uncontracted, neutral state and in a contracted state;

FIG. 2 shows a schematic representation of a blind rivet according to a further exemplary embodiment;

FIG. 3 shows a schematic representation of a bearing collar;

FIG. 4 shows a schematic representation of a system for producing blind rivet connections; and,

FIG. 5 shows a schematic representation of a method for producing blind rivet connections.

### DETAILED DESCRIPTION OF THE PREFERRED EMBODIMENTS

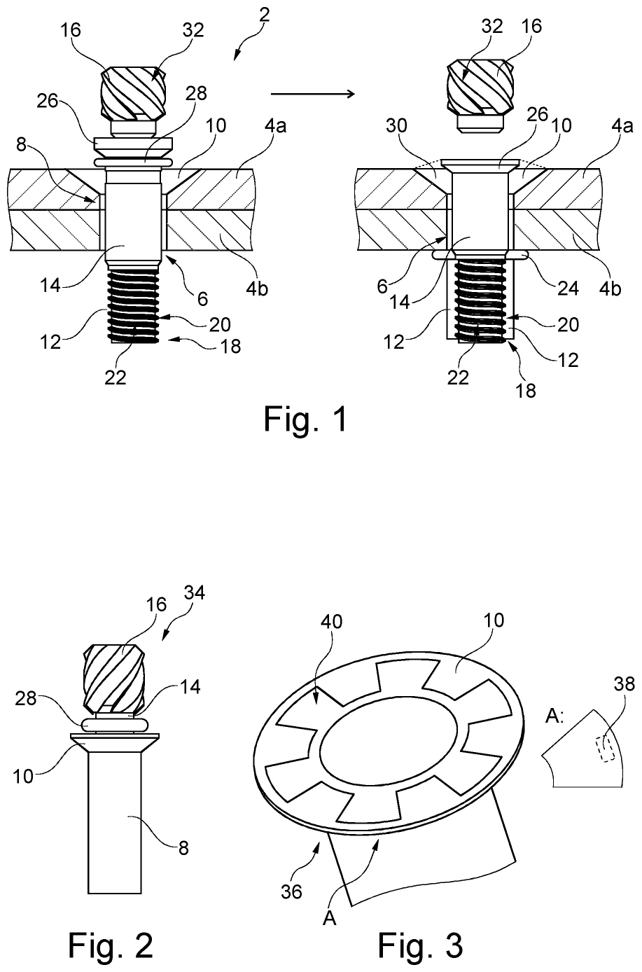

FIG. 1 shows a blind rivet 2 for connecting workpieces 4a and 4b. These could be made from metallic sheet metal or a plastic material, for example, possibly with fiber reinforcement, and might be used for an aircraft component or similar application. The two workpieces 4a and 4b lie flush with one another and have a rivet hole 6 that extends completely through both workpieces 4a and 4b. The blind rivet 2 is inserted into the rivet hole 6 and is located on the left side of the drawing plane in a neutral (delivery) state.

The blind rivet 2 comprises a hollow, deformable rivet body 8 with a bearing collar 10 and a sleeve 12 attached thereto. Inside the sleeve 12 is a rivet mandrel 14 which comprises a tool holder head 16 positioned outside the sleeve 12. The sleeve 12 has an internal thread 20 at an end 18 facing away from the tool holder head 16, while the rivet mandrel 14 has an external thread 22 complementary thereto in that location. By rotating the rivet mandrel 14, with the position of the mandrel 14 unchanged, the end 18 of the sleeve 12 is pressed against the external thread 22 in the direction of the rivet hole 6. The sleeve 12 is then deformed accordingly. This is shown on the right side of the drawing plane. The deformation leads to radial bulges 24 in the sleeve 12 which compress the workpieces 4a and 4b together with the bearing collar 10.

By way of example, the rivet mandrel 14 has a circumferential collar 26 that is pressed during the contraction of the sleeve 12 in the direction of the bearing collar 10. Between the circumferential collar 26 and the bearing collar 10, there is a sealing ring 28 made of a curable sealing material. After being positioned on the blind rivet 2, the sealing material is in a state that allows for a ring-shaped arrangement around the rivet mandrel 14, yet it is sufficiently paste-like or pliable to be radially compressed during the contraction of the rivet body 8. During the contraction of the rivet body 8 and the pressing of the circumferential collar 26 against the bearing collar 10, a layer of sealing material 30 is therefore created by compressing the sealing ring 28, which layer of sealing material extends over the entire bearing collar 10 when the sealing ring 28 is properly sized. Any gaps or spaces between the outer workpiece 4a and the bearing collar 10 or between the bearing collar 10 and the circumferential collar 26 are thereby completely covered. It may be advisable for the sealing material to be filled subsequently or smoothed with a putty knife.

On the right side of FIG. 1, the tool holder head 16 is depicted in a broken-off state, which is achieved through the complete contraction of the rivet body 8 by exceeding a predetermined torque limit. The rivet connection is then complete. By way of example, the tool holder head 16 has a first profile 32 that is designed to match a second profile of a tool (not shown here) for connecting the tool and the tool holder head 16.

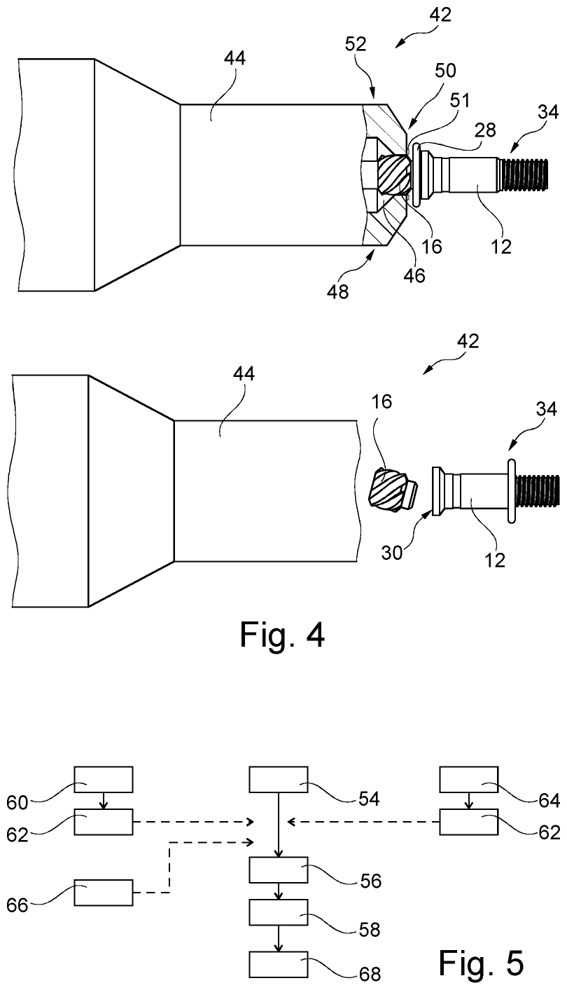

FIG. 2 shows an alternative embodiment of a blind rivet 34, in which the rivet body 8 is configured in the same manner, but the rivet mandrel 14 does not include a circumferential collar 26. The sealing ring 28 is arranged directly between the tool holder head 16 and the bearing collar 10. During the contraction of the rivet body 8, a tool nose piece (see FIG. 4) is pressed via the sealing ring 28 onto the bearing collar 10, so that the sealing material is thereby compressed.

In FIG. 3, the bearing collar 10 is shown in an oblique plan view. On an underside 36 facing away from the tool holder head 16, the bearing collar 10 has multiple projections 38 distributed over the bearing collar 10. The projections 38 press into the outer workpiece 4a, thereby counteracting a rotation of the rivet body 8.

It is conceivable for notches 40 to be provided on the side facing the tool holder head 16 too, which can be brought into form-fitting engagement with the tool nose piece (see FIG. 4), in order to counteract rotation of the rivet body 8. By compressing the sealing material, the notches 40 are filled with the sealing material. Subsequent filling can completely distribute the sealing material within the notches 40.

FIG. 4 shows a system 42 for producing sealed blind rivet connections. In this case, a blind rivet 34 is shown as in FIG. 2, which is coupled with a tool 44. The tool holder head 16 in this case is inserted into a second profile 46, enabling it to be rotated by the tool 44. The tool 44 has a tool nose piece 48 which has a nose surface 50 that can be brought into contact with the sealing ring 28, which nose surface 50 is arranged, for example, in a ring around a receiving opening 52 of the tool 44. This can act on the sealing ring 28 when the rivet body 8 contracts, so that said sealing ring forms the sealing material layer 30, as depicted in the lower representation in FIG. 4. Only by way of example, the nose surface 50 may have engagement elements 51 which engage with the notches 40 in the rivet body 8, if these are provided and desired.

Finally, FIG. 5 shows a method for producing sealed blind rivet connections on workpieces, encompassing the steps of making 54 the rivet hole 6 in the workpieces 4a and 4b, inserting 56 the blind rivet 2 or 34 into the rivet hole 6 and contracting 58 the rivet body 8 using the tool 44 while compressing the at least one sealing ring 28. The at least one sealing ring 28 in this case may be a two-component mixture, shaped into a ring-like bead 60 before inserting 56 the blind rivet 2 or 34, and placed 62 onto the blind rivet 2 or 34. Alternatively, the at least one sealing ring 28 could be removed from an airtight and/or cooled packaging 64 immediately before inserting 56 the blind rivet 2 or 34 and placed 62 onto the blind rivet 2 or 34, or the blind rivet 2 or 34, with the sealing ring 28 fitted, could be removed from an airtight and/or cooled packaging 66 immediately before inserting 56.

Upon completion of the blind rivet connection, the sealing material can be filled 68.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

2 blind rivet
4a, 4b workpiece
6 rivet hole
8 rivet body
10 bearing collar
12 sleeve
14 rivet mandrel
16 tool holder head
18 end
20 internal thread
22 external thread
24 radial bulge
26 circumferential collar
28 sealing ring
30 sealing material layer
32 first profile
34 blind rivet
36 underside
38 projection
40 notch
42 system
44 tool
46 second profile
48 tool nose piece
50 nose surface
52 receiving opening
54 making the rivet hole
56 inserting the blind rivet
58 contracting the rivet body
60 shaping into a ring-like bead
62 placing onto the blind rivet
64 removing sealing ring from airtight and/or cooled packaging
66 removing blind rivet from airtight and/or cooled packaging
68 filling

Claimed is:

1. A blind rivet for connecting workpieces, the blind rivet comprising:
a hollow, deformable rivet body with a bearing collar and a sleeve attached thereto;
a rivet mandrel arranged in the sleeve and extending through the bearing collar, having a tool holder head, and
at least one sealing ring;
wherein the at least one sealing ring is arranged between the bearing collar and the tool holder head;
wherein the at least one sealing ring is made of a curable and not fully cured sealing material;
wherein the at least one sealing ring is arranged in such a manner that during contraction of the blind rivet it is pressed axially towards the bearing collar by a tool that is configured to be connected to the tool holder head or by a section of the rivet mandrel, and,
wherein the at least one sealing ring is configured to flow radially and axially into gaps and spaces on the bearing collar and between the bearing collar and the workpieces while the sealing ring is compressed, and to adhere there.

2. The blind rivet according to claim 1, wherein the rivet mandrel comprises an external thread at an end facing away from the tool holder head,
wherein the external thread corresponds to an internal thread in the sleeve, and
wherein the tool holder head has a first profile to transfer rotation from the tool to the rivet mandrel, which first profile corresponds to a second profile of a tool.

3. The blind rivet according to claim 1, wherein the rivet mandrel has a circumferential collar that rests on the bearing collar of the rivet body.

4. The blind rivet according to claim 3, wherein the at least one sealing ring is arranged between the circumferential collar and the bearing collar.

5. The blind rivet according to claim 3, wherein the at least one sealing ring is arranged between the tool holder head and the circumferential collar.

6. The blind rivet according to claim 1, wherein the bearing collar has protrusions on a side facing away from the tool holder head, said protrusions become wedged with the workpieces during the contraction of the blind rivet and preventing the rivet body from rotating.

7. The blind rivet according to claim 1, wherein the bearing collar has notches on a side of the bearing collar facing the tool holder head, and
wherein the at least one sealing ring is dimensioned such that the notches are filled with sealing material after the contraction of the blind rivet.

8. The blind rivet according to claim 1, wherein the tool holder head is free from cetyl alcohol.

9. The blind rivet according to claim 1, further comprising:
a resin coating.

10. The blind rivet according to claim 1, wherein the at least one sealing ring is heat-curable, UV-curable, moisture-curing, or a combination thereof.

11. The blind rivet according to claim 1, wherein the at least one sealing ring is configured to be filled immediately following the contraction of the blind rivet.

12. The blind rivet according to claim 1, wherein the at least one sealing ring is a two-component mixture, which is prepared before attaching the at least one sealing ring or is realized in a form of two contactable sealing rings with components which are separate from one another and mix with one another upon contraction.

13. A system for producing sealed blind rivet connections, the system comprising:
the blind rivet according to claim 1; and
at least one tool configured to be connected to the tool holder head.

14. The system according to claim 13, wherein the at least tool has a tool nose piece with a nose surface configured to be brought into contact with the at least one sealing ring and wherein the nose surface is coated with a release agent.

15. A method for producing sealed blind rivet connections on workpieces, the method comprising the steps:
creating a rivet hole in the workpieces;
inserting the blind rivet according to claim 1 into the rivet hole; and
contracting the rivet body using a tool while the at least one sealing ring is compressed.

16. The method according to claim 15, wherein the at least one sealing ring is a two-component mixture which is formed into a ring-shaped bead before the blind rivet is inserted and placed onto the blind rivet.

17. The method according to claim 15, wherein the at least one sealing ring is configured to be removed immediately before the blind rivet is inserted from an airtight package, a cooled package, or a combination thereof, and placed onto the blind rivet, or
wherein the blind rivet with the at least one sealing ring fitted is removed immediately prior to insertion from an airtight packaging, a cooled packaging, or a combination thereof.
